(19) United States
(12) Patent Application Publication
(10) Pub. No.: US 2009/0295044 A1
(43) Pub. Date: Dec. 3, 2009

(54) Method For Marking Ceramic Structures

(76) Inventors: Jeffrey Michael Amsden, Hammondsport, NY (US); L Urdenis Johnson, Tyrone, PA (US); Jeremy Jason Schermerhorn, Taylorsville, NC (US); David Lambie Tennent, Campbell, NY (US); Christopher John Warren, Waverly, NY (US)

Correspondence Address: CORNING INCORPORATED, SP-TI-3-1, CORNING, NY, 14831, US

(21) Appl. No.: 12/473,894

(22) Filed: May 28, 2009

Related U.S. Application Data
(60) Provisional application No. 61/130,386, filed on May 30, 2008.

(51) Int. Cl. C04B 35/64

(52) U.S. Cl. 264/630

(57) ABSTRACT

A method is provided for marking a structure containing an ceramic-forming component by applying onto a green body a high temperature ink that has a metal-containing species and a metal complexing agent, wherein the metal in the metal-containing species reacts with the ceramic-forming component during firing of the green body to produce a compound that forms a contrasting mark on the resulting ceramic structure. A method is also provided for marking a ceramic-forming green body by applying a two-dimensional dot matrix mark formed of a high temperature ink onto a surface of the ceramic-forming green body, wherein each dot of the two-dimensional dot matrix is formed of a single drop of the high temperature ink.

### CROSS-REFERENCE TO RELATED APPLICATIONS

This application claims the benefit of priority to U.S. application No. 61/130,386, filed on May 30, 2008.

### FIELD

This disclosure generally relates to a method for marking a ceramic structure, and is specifically concerned with applying a high temperature ink onto a surface of a ceramic-forming green body, wherein the ink chemically reacts with an ingredient of the green body during firing to produce a compound exhibiting a visibly contrasting mark on the resulting ceramic structure.

### BACKGROUND

Ceramic honeycomb structures are widely used as anti-pollutant devices in the exhaust systems of automotive vehicles, both as catalytic converter substrates in automobiles, and diesel particulate filters in diesel-powered vehicles. In both applications, the ceramic honeycomb structures are formed from a matrix of relatively thin ceramic webs which define a plurality of parallel, gas conducting channels. In honeycomb structures used as ceramic catalytic substrates, the cell density may be as high as about 900 cells per square inch. To reduce the pressure drop that the exhaust gases create when flowing through the honeycomb structure, the web walls are rendered quite thin, i.e. on the order 2-6 mils. Ceramic honeycomb structures used as diesel particulate filters generally have a lower cell density of between about 100 and 400 cells per square inch, and are formed from webs on the order of 12-25 mils thick. In both cases, the matrix of cells is surrounded by an outer skin.

Such ceramic honeycomb structures may be formed by an extrusion technique in which an extruded body is cut into segments that form green ceramic bodies. After drying, these honeycomb green bodies are fired at temperatures of at least 1100° C. or higher, and typically 1300° C. or higher in order to sinter the batch constituent particles present in the extruded material into a finished ceramic honeycomb structure. The finished fired honeycomb bodies may be subjected to additional heating steps in which they are fired again to lower temperatures, for example, on the order of 800° C. or more. The finished ceramic structures may also be subjected to a coating process that coats the gas contacting surfaces with a wash coat, possibly containing catalytic metals. In this application, the term “unfinished” ceramic structure refers to any precursor to a finished ceramic structure, including a dried green body or an unfired or partially fired green body.

Unfortunately, due to the thinness of the outer skin and the inner cell-forming webs, the substantial thermal stresses that the unfinished ceramic structures undergo during the firing processes, and the necessary mechanical handling of the green and fired bodies during the manufacturing process, defects such as internal cracks and voids may occur, as well as separations between the outer skin and the inner matrix of webs. Additionally, upsets due to raw material deviations from specifications may also occur possibly leading to property variations. To reduce the occurrence of such defects, it would be desirable to have a quality control procedure which allowed the manufacturer to reliably trace any defective ceramic honeycomb structure back to the specific factory, kiln, and batch that it originated from and to other processing steps undertaken. Such a procedure would allow the manufacturer to review the particular manufacturing parameters used to fabricate the defective unit and to modify its manufacturing operation in order to reduce the occurrence of such defects in future articles. Accordingly, it is a known procedure to mark, after the final firing or heating step, finished ceramic honeycomb structures with marks containing manufacturing information so that remedial manufacturing operations may be implemented.

Unfortunately, the applicants have observed that such a marking procedure does not reliably result in an accurate recovery of the manufacturing information associated with a particular ceramic honeycomb structure. In particular, the applicants have observed that subsequent to the manufacture of the green bodies of such structures, different batches of green bodies from different kilns may become mixed together in order to efficiently implement other stages of the fabrication process. Hence a quality control process where manufacturing information is printed on the finished ceramic honeycomb structures may not accurately reflect the actual manufacturing conditions and history of the structures, i.e., reliable traceability is not achievable.

To avoid the aforementioned problems, it is necessary to print a data carrying mark on the skin of the green bodies that ultimately form finished completed ceramic honeycomb structures. However, there are a number of problems associated with implementing such a method due to both the fragility of the green bodies, the high temperatures they are subjected to during the firing process, the speed with which they must be marked in order to avoid a production bottleneck, and the tendency of some inks to run or blur when printed on the green body, or to degrade or react with the unfired material forming the skin of the green body.

Accordingly, there is a need for a system and method for printing a data-carrying mark on the skin of a green ceramic honeycomb structure which does not apply potentially damaging pressure on the thin sidewalls of such structures, and which is capable of withstanding the firing temperatures at or above 800° C., at or above 1100° C., or even at or above 1300° C. Ideally, such a method would be capable of printing a unique mark on each one of a particular batch of green ceramic structures, so that the manufacturing history of each particular ceramic honeycomb structure (such as date of manufacture, specific factory, kiln and batch) can be accurately traced. It would be desirable if the information contained in the resulting mark would be maintained even if a portion of the mark were obliterated during the use of the ceramic honeycomb structure.

Such a marking system and method should be rapid and reliable and compatible with high-speed manufacturing techniques so as not to create an expensive production bottleneck. The ink used to form the mark should be nontoxic, and able to produce a compound that can survive firing temperatures of at least 800° C., or even 1100° C. or more, or even 1300° C. or more, and be chemically compatible with the unfired ceramic material forming the body. The ink should not blur or run when printed, and it should have similar thermal expansion and contraction properties so as to create a clear mark that does not crack or peel during the firing and cooling steps of manufacture, and does not create excessive thermal stresses. Finally, the ink should not degrade or react with the ceramic material forming the wall of the structure during any phase of the manufacturing process, and should visibly contrast not only against the fired ceramic material forming the finished structure, but also against any catalytic wash coat applied to the structure.

### SUMMARY

This disclosure relates to a method for providing a mark on a ceramic structure by applying a high temperature ink, onto a surface of a ceramic-forming green body structure, wherein the ink chemically reacts with an ingredient of the green body structure during firing of the green body to produce a compound that exhibits a visibly contrasting mark on the resulting ceramic structure.

In one embodiment, the method includes marking a ceramic structure, such as an aluminum titanate, by applying onto a green body containing an aluminum titanate ceramic-forming component, a high temperature ink that includes a metal-containing species and a metal complexing agent; and firing the green body causing the metal in the metal-containing species to react with the aluminum titanate ceramic-forming component, thereby forming a compound that exhibits a mark on the ceramic structure that visibly contrasts with adjacent, unmarked portions of the ceramic structure.

In another embodiment, the method includes marking a ceramic-forming green body by applying onto a surface of the ceramic-forming green body, a two-dimensional dot matrix mark formed of a high temperature ink wherein each dot of the two-dimensional dot matrix is formed of a single drop of the high temperature ink.

The mark in one embodiment is a data-carrying mark that includes selected manufacturing information, such as a two-dimensional dot matrix code. The code is readable after the firing step resulting in a visibly-contrasting mark that includes all of the selected manufacturing information.

### DESCRIPTION OF THE DRAWINGS

FIG. 1 is a side view of a marking apparatus in accordance with the disclosure;

FIG. 2 is a perspective view of an enlargement of a green ceramic honeycomb structure that has been marked with a two-dimensional bar code;

FIG. 3 is a cross-sectional view of the pump of the print dispenser; and

FIG. 4 is a cross-sectional view of the needle position and drop formation sequence of the pump.

### DETAILED DESCRIPTION

This disclosure relates to a method for providing a mark on a ceramic structure by applying a high temperature ink, onto a surface of a ceramic-forming green body structure, wherein the ink has an agent that chemically reacts with an ingredient of the green body structure during firing of the green body to produce a compound that exhibits a visibly contrasting mark on the resulting ceramic structure. The ink media is applied as a liquid and the ink is soluble in a carrier liquid. The phrase “high temperature ink” is meant to describe ink that can chemically react with an ingredient of the green body structure during firing and form a new compound exhibiting a visibly-contrasting mark and produce bar code data capable of being read by conventional bar code reading equipment after firing that can withstand firing temperatures of at least about 800° C. in one embodiment, at least about 1100° C. in another embodiment, and at least about 1425° C. in another embodiment, and for at least about 6 hours in another embodiment.

In one embodiment, for example, the green body includes a titanium-containing component, although the present disclosure is not limited to a titanium-containing green body. Other metal-containing green bodies known to those skilled in the art are contemplated by the present method, which include cordierite materials. An example of a titanium-containing green body is a green body containing an aluminum titanate ceramic-forming component. In accordance with this embodiment, the method includes marking an aluminum titanate ceramic structure by applying onto a green body containing an aluminum titanate ceramic-forming component, a high temperature ink that includes a metal-containing species and a metal complexing agent; and firing the green body causing the metal in the metal-containing species to react with the aluminum titanate ceramic-forming component, thereby forming a compound which exhibits a mark on the ceramic structure that visibly contrasts with adjacent, unmarked portions of the ceramic structure.

In another embodiment, the method includes marking a ceramic-forming green body by applying onto a surface of the ceramic-forming green body, a two-dimensional dot matrix mark formed of a high temperature ink wherein each dot of the two-dimensional dot matrix is formed of a single drop of the high temperature ink.

The green body may be fired at a temperature of between about 1100° C. and 1500° C. for 12 to 16 hours, and in one embodiment, at a temperature of at least about 1300° C. In another embodiment, the green body is fired at a temperature of about 1425° C. and held for about 6 hours.

Suitable metal-containing species in the ink include those which react with an ingredient in the extruded green part to produce a compound which exhibits a mark that is darker than the fired product. In one embodiment, the reacting agent in the ink includes a soluble metal-containing species wherein the metal is Fe, Cr, Mn, Co, Mo, V or Ru. Typically, the metal-containing species is Fe. In one embodiment, the metal-containing species of the ink is provided in solution form, such as in water, alcohol, methanol, oil, etc. For example, the ink may be an aqueous solution of one of the metal species. The metal-containing species can be a soluble iron-containing species, such as iron chloride, iron acetate, or iron nitrate. Other ink materials include ferrocene, ferro- and ferric-cyanide compounds, prussian blue (ferric ferrocyanide), and hemeproteins. Other biological sources of iron that are soluble in the ink media are also suitable, provided that they can react with the TiO₂ or other ingredient in the extruded green body to produce a mark.

Suitable metal complexing agents include any metal complexing agent known to be soluble in the ink media. In one embodiment, the metal complexing agent includes EDTA, citric acid, picric acid, aceytlacetone, isocyanate, thiocyanite, histidine, lactic acid, tartaric acid, malaic acid, acetic acid, or imidazole.

In one embodiment, the molar ratio of the metal (iron) species to the metal (iron) complexing agent is 1:1. More of the complexing agent could be added without adversely affecting performance. Also, less than the 1:1 ratio could be achieved, resulting in some of the metal eventually precipitating out of solution and ending up as a solid on the bottom of the ink reservoir. The purpose of the complexing agent is to keep the metal species in solution. When the solution is prepared and used immediately (e.g., within a day), the complexing agent may not be needed. In one embodiment, use of the complexing agent results in the metal remaining in solution for at least about one week. In another embodiment use of the complexing agent results in the metal remaining in solution for at least about 3 months.

More specifically, the wall of the unfinished ceramic structure may include, for example, titania, and the ink may include, for example, an aqueous solution of an iron compound such as FeCl₂.4H₂O, FeCl₃.6H₂O and/or (FeNO₃)₂.9H₂O that forms iron titanate when the unfinished ceramic body is fired. The iron titanate compound exhibits a mark on the ceramic structure that visibly contrasts with adjacent, unmarked portions of the ceramic structure. In one embodiment, the concentration of the iron compound is in a range of from about ½ M to about 4 M in the aqueous solution. In another embodiment, the concentration of the iron compound is sufficient to provide a saturated solution. In another embodiment, the concentration of the iron compound is in a range of from about ½ M to about a concentration sufficient to provide a saturated solution. In one embodiment the viscosity of the ink media is 6 cps. The following examples are meant to illustrate particular embodiments and are not meant to be limiting.

| | EXAMPLE | | | |
|---|---|---|---|---|
| | 1 | 2 | 3 | 4 |
| Concentration (molar) | 1 | 2 | 3 | 4 |
| Iron (II) Chloride Tetrahydrate (g) | 9.9 | 19.8 | 29.7 | 39.6 |
| EDTA (g) | 1 | 1 | 1 | 1 |
| DI Water (g) | 50 | 50 | 50 | 50 |

In one embodiment, the mark is a data-carrying mark that includes selected manufacturing information, such as a two-dimensional barcode, and the method may further include the step of reading the mark after the firing step to determine if the resulting, visibly-contrasting mark includes all of the selected manufacturing information.

Certain embodiments include the step of applying onto a surface of the ceramic-forming green body, a two-dimensional dot matrix mark formed of a high temperature ink wherein each dot of the two-dimensional dot matrix is formed of a single drop of the high temperature ink. The data matrix code is a substantially square or substantially rectangular image made of a series of cells. Each cell either contains or does not contain a mark. In one embodiment, the mark in each cell is substantially round and not necessarily contiguous with a mark in an adjacent cell. In one embodiment, the mark in a cell is made of one drop of ink. The individual drop volume is selected to substantially fill an individual cell. In another embodiment, an individual cell may be filled by one or more drops, such as 2, 3, 4, 5, 6, 7, 8, 9, or 10 drops. The high temperature ink includes a soluble metal species, a metal complexing agent, and a carrier liquid. The soluble metal species is provided in an amount such that the species is substantially fully soluble in water. In one embodiment, the ceramic-forming green body is formed from a batch capable of forming aluminum titanate, and in another embodiment an aluminum titanate-forming honeycomb.

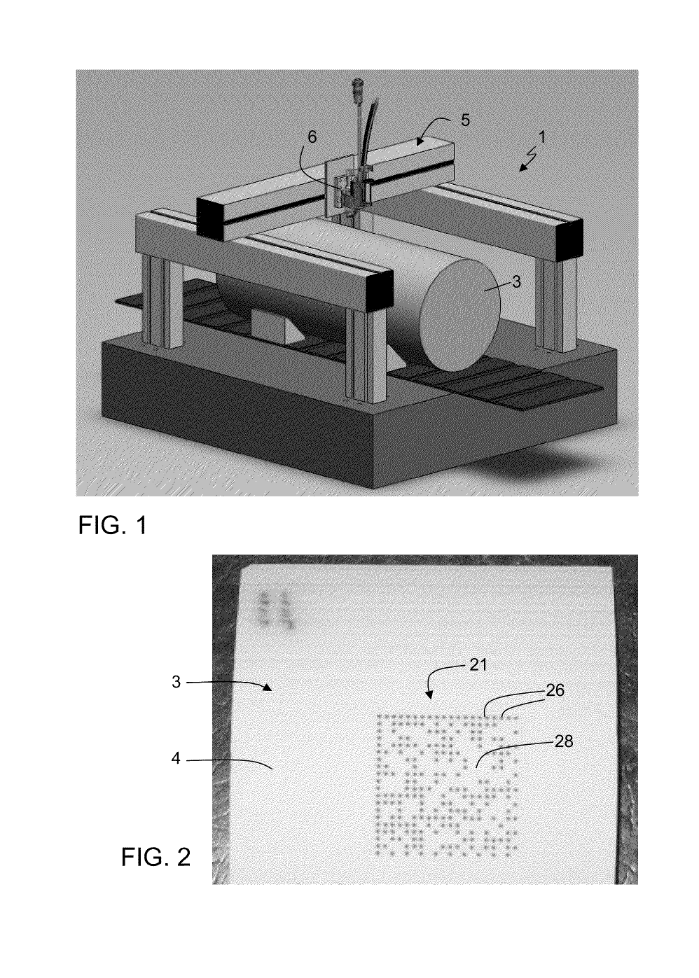

With reference now to FIG. 1, wherein like numerals designate like components throughout all the several figures, the marking apparatus 1 for marking green body or otherwise unfinished ceramic structure of a ceramic honeycomb structure includes a software programmed motion control system 5, and a dispensing pump 6.

The pump dispenses ink so as to be able to expeditiously print a two-dimensional dot matrix bar code. The pump is provided with an ink reservoir (not shown) for storing a high temperature ink. The apparatus further includes a radial distance adjuster (not shown) that moves the pump dispenser toward and away from the periphery of the workpiece as well as a vertical height adjuster (not shown) for moving the pump up or down. Finally, the pump includes an attitude adjuster (not shown) so that the pump may be oriented orthogonally with respect to the outer wall 4 of the green ceramic body 3 prior to the marking operation.

The pump system dispenses the high temperature marking ink. Commercially available dispensing systems suitable for use in the present method include the DJ-9000 DispenseJet available from Asymtek, Carlsbad, Calif. The pump is moved into the precise position by an X,Y,Z positioning system. The part is conveyed under the pump on a pallet and fixed in position when the part is being marked. The X,Y locations for the dots in the two-dimensional barcode are fed continuously into a motion controller from a database or production line PLC controller. The controller checks the substrate height then moves the pump into the proper positions to fire the dots that make up the two-dimensional barcode. The pump deposits one or more dots at each position of the two-dimensional barcode.

FIG. 2 illustrates an example of the data carrying mark 21 that the marking apparatus applies to the side wall 4 of a green body 3. The mark 21 includes a machine-readable component, such as a two-dimensional dot matrix code. The machine-readable component preferably includes a digital pattern of printed dot portions 26 and unprinted portions 28 in order to maximize the optical contrast between the printed and unprinted portions, thereby reducing the chance of a reading error. The machine readable component may of course be a one dimensional bar code or virtually any type of information carrying pattern of marked and unmarked portions. However, a two-dimensional bar code is one embodiment of the mark as up to 30% of such marks can be obliterated without loss of information.

The mark 21 may contain specific manufacturing information, such information as the specific factory and/or kiln that produced the green body 3, the particular batch that the green body 3 belonged to at the time of production, the date of production, and/or a unique individual identification code (no two of which are alike for some significant period of time). In one implementation, the unique individual identifier identifies the station that placed the mark on the honeycomb body, the date (such as a julien date), and a sequential number of the honeycomb body manufactured on that date (e.g. number 28 or 1410 manufactured that day). The unique identifier may be further encrypted, by a suitable encryption code to make it difficult for the coded information to be reverse engineered, except by the manufacturer, who of course, holds the key to the encryption code. The unique identifier may be placed on the honeycomb structure at any suitable time in the manufacturing sequence. For example, the mark may be printed on the side wall of the honeycomb just after the drying or cutting steps where a high temperature resistant ink is used that creates a compound that can survive firing, or later, after firing, where a low temperature marking ink is used.

Data for each unique individual identifier assigned and relating to an individual honeycomb is stored in a relational database during the manufacturing sequence and may later be extracted at any time. As such, the origin, manufacturing materials and processes used, and equipment and apparatus used to manufacture the honeycomb, as well as performance, properties, and attributes of the honeycomb may be readily looked up. Accordingly, any defect or variation in the honeycomb may be readily related to the materials, processes, and equipment use. Thus, if desired, changes may be made in the raw materials, processes, etc. to effect changes in properties or attributes.

The unique identifier information is generated by a computer program that ensures that the code is unique to that honeycomb, and that honeycomb alone, for significant periods of time, for example, greater than a decade. This allows for traceability of that particular honeycomb to any process it underwent during its manufacture, including traceability to the raw materials used, the specific batches and processes employed, the date of manufacture, specific extruder lines and extrusion dies used, particular kilns and firing cycles, as well as finishing operations employed.

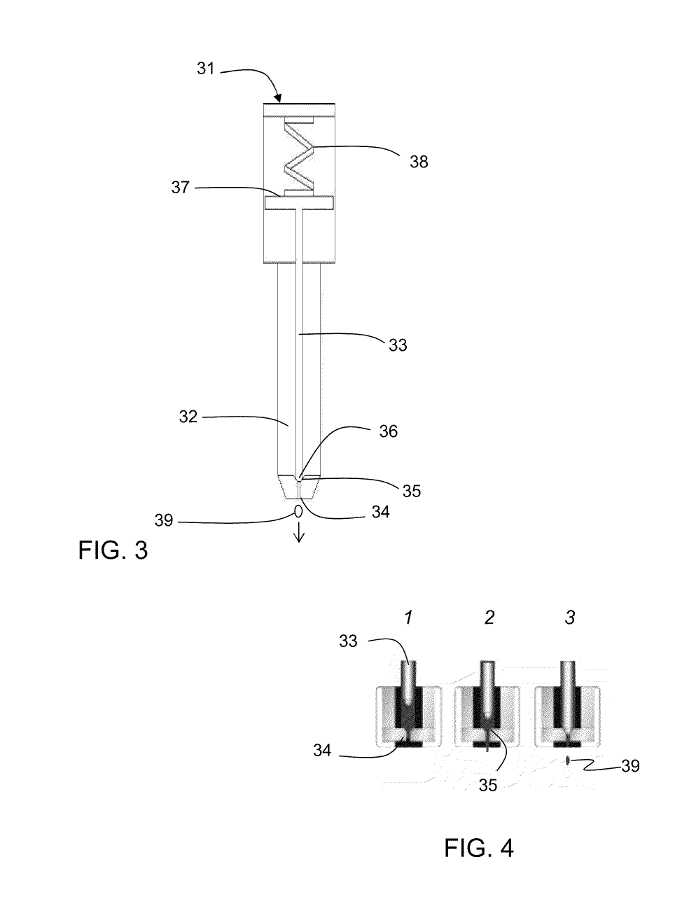

A schematic of the pump 31 is shown in FIG. 3. To operate the pump 31 printing material is loaded in a syringe. The syringe is loaded on the dispensing system pump 31. A plastic tube is connected from the syringe to the fluid chamber 32 of the pump 31. Air pressure is applied on top of the ink in the syringe forcing the material into the fluid chamber 32. The needle 33 moves up and down in the fluid chamber 32 and the droplets are shot out of the nozzle 34 on the downward stroke. When the needle 33 retracts fluid fills the fluid chamber 32. When the needle 33 moves forward against the nozzle seat 35 it forces a droplet of material 39 to be shot out of the nozzle 34. The needle 33 is normally seated with its ball end 36 against the nozzle seat 35 in the closed position. The top of the needle 33 is attached to a pneumatic piston 37. A compression spring 38 applies force on the top of the needle 33 holding it against the nozzle seat 35. When air pressure is applied to the bottom of the piston 37 a force greater than the force of the spring 38 is created lifting the needle 33 off of the nozzle seat 35. When the air pressure is removed the force of the spring 38 moves the needle 33 rapidly down against the nozzle seat 35. The kinetic energy from the needle 33 is imparted on the fluid in the fluid chamber 32 which shoots a droplet of material 39 out of the nozzle 34. A schematic of the needle position and drop formation sequence are shown in FIG. 4.

While this method has been described with respect to several embodiments, various modifications, additions, and variations will become evident to the persons in the art. All such variations, additions, and modifications are encompassed within the scope hereof, which is limited only by the appended claims, and the equivalents thereto.

What is claimed is:

1. A method for marking a ceramic structure, comprising the steps of:
applying onto a green body, which comprises a ceramic-forming component, a high temperature ink that comprises a metal-containing species and a metal complexing agent; and
firing the green body causing the metal in the metal-containing species to react with the ceramic-forming component, thereby forming a compound which exhibits a mark on the ceramic structure that visibly contrasts with adjacent, unmarked portions of the ceramic structure.

2. The method of claim 1, wherein the metal complexing agent is EDTA, citric acid, picric acid, aceytlacetone, isocyanate, thiocyanide, histidine, lactic acid, tartaric acid, malaic acid, acetic acid, or imidazole.

3. The method of claim 1, wherein the metal-containing species is Fe, Cr, Mn, Co, Mo, V, or Ru.

4. The method of claim 1, wherein the metal-containing species is Fe.

5. The method of claim 4, wherein the ink comprises FeCl₂.4H₂O, FeCl₃.6H₂O, or (FeNO₃)₂.9H₂O.

6. The method of claim 1, wherein the ink comprises a carrier liquid, and the metal-containing species is soluble in the carrier liquid.

7. The method of claim 1, wherein the ink is an aqueous solution of one or more metal compounds at a concentration in a range from about ½ M to about a saturated solution.

8. The method of claim 1, wherein the ink is an aqueous solution of one or more metal compounds at a concentration of about 4M.

9. The method of claim 1, wherein the green body is fired at a temperature of at least about 1100° C.

10. The method of claim 1, wherein the green body is fired at a temperature of at least about 1300° C.

11. The method of claim 1, wherein the applying step comprises using a single drop ink dispenser to apply the ink in the form of a machine readable code.

12. The method of claim 11, wherein the machine readable code is a two-dimensional dot matrix code.

13. The method of claim 12, wherein the two-dimensional dot matrix code comprises a series of dots that make up a substantially square or substantially rectangular image.

14. A method for marking a ceramic-forming green body, comprising the steps of:
applying onto a surface of the ceramic-forming green body, a two-dimensional dot matrix mark formed of a high temperature ink wherein each dot of the two-dimensional dot matrix is formed of a single drop of the high temperature ink.

15. The method of claim 14, wherein the high temperature ink reacts with the ceramic-forming green body during firing to form a compound that survives a temperature at or above about 800° C.

16. The method of claim 15, wherein the compound survives firing at a temperature at or above about 1100° C.

17. The method of claim 14, wherein the green body is formed from a batch capable of forming aluminum titanate.

18. The method of claim 14, wherein the green body comprises an aluminum titanate-forming honeycomb.

19. The method of claim 14, wherein the high temperature ink comprises a soluble metal species, a metal complexing agent, and a carrier liquid.

20. The method of claim 14, wherein the soluble metal species is provided in an amount such that the species is substantially fully soluble in water.

21. The method of claim 14, wherein the complexing agent is provided in an amount sufficient to keep the metal in solution for at least about one week.
